(19) United States
(12) Patent Application Publication
(10) Pub. No.: US 2013/0250403 A1
(43) Pub. Date: Sep. 26, 2013

(54) HIGH INFRARED TRANSMISSION WINDOW WITH SELF CLEANING HYDROPHILIC SURFACE

(71) Applicant: Patrick Yasuo Maeda, Mountain View, CA (US)

(72) Inventor: Patrick Yasuo Maeda, Mountain View, CA (US)

(73) Assignee: PALO ALTO RESEARCH CENTER INCORPORATED, Palo Alto, CA (US)

(21) Appl. No.: 13/427,315

(22) Filed: Mar. 22, 2012

(51) Int. Cl. G06K 7/10; B05D 5/06

(52) U.S. Cl. 359/350; 427/162

(57) ABSTRACT

An optical transmission window includes a dielectric substrate that is transparent at an infrared wavelength. A titanium dioxide coating is disposed on an external surface of the dielectric substrate. The titanium dioxide coating has an optical thickness of m plus one-half of the infrared wavelength, where m is a whole number greater than or equal to zero.

### SUMMARY

Various embodiments described herein are generally directed to methods, systems, and apparatuses that facilitate high infrared transmission through a window having a hydrophilic surface. In one embodiment, an optical transmission window includes a dielectric substrate that is transparent at an infrared wavelength. A titanium dioxide coating is disposed on an external surface of the dielectric substrate. The titanium dioxide coating has an optical thickness of m plus one-half of the infrared wavelength, where m comprises a whole number greater than or equal to zero.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIGS. 1A-1C are block diagrams of window structures according to example embodiments;

FIGS. 2A-2B are graphs illustrating analytic results of reflectivity versus wavelength for window structures according to example embodiments; and

FIG. 3 is a flowchart illustrating a procedure according to an example embodiment.

### DETAILED DESCRIPTION

The present disclosure relates generally to a window usable for optical devices that operate over a predefined range of wavelengths. In addition to providing isolation from the physical environment, the window is self-cleaning, anti-fogging, and anti-spotting. Such a window can be used, for example, to enclose an optical device such as an infrared (IR) camera that operates over a relatively small range of wavelengths. In such a case, the window can be formed of materials and dimensions that optimize self-cleaning properties, even if it results in optical performance that might be sub-optimal for wider-band optics uses (e.g., a visible light camera).

There are at least two different technical approaches for self-cleaning coatings: hydrophilic and hydrophobic. Both types of coatings clean themselves through the action of water. In the case of the hydrophobic surface, rolling droplets take away dirt and dust. In the case of the hydrophilic surface, sheeting water carries away dirt. In the present embodiments, a titanium oxide (e.g., titanium dioxide, TiO₂) coating is described as being used as a hydrophilic self-cleaning surface. Although alternate metal oxides may be used, TiO₂ is described in the examples illustrated herein because it has highly efficient photoactivity, is quite stable, and is available at low cost.

A TiO₂ coating material has photocatalytic and photo-induced hydrophilic properties when combined with ultraviolet (UV) light. The UV light can be from ambient sunlight or other UV light sources. The hydrophilic property of a TiO₂ coating prevents fogging, water spotting, and promotes a washing flow of rain water instead of beading. The photocatalytic properties of a TiO₂ coating prevents the buildup of dirt, dust, and various organic materials. A photochemical reaction proceeds on a TiO₂ surface when irradiated with ultraviolet light. This causes photo adsorption which results in decomposition of organic substances. The decomposition is effective when the number of incident photons is much greater than that of filming molecules arriving on the surface per unit time.

A TiO₂ layer may be used as a durable thin film dielectric material for optical coatings, with some restrictions. A TiO₂ coating has a relatively high refractive index (approximately 2.6) which produces a single surface Fresnel reflection of approximately 20% at an air interface. So arbitrarily applying the material over a window or lens can significantly reduce the optical transmission of the window or lens. As a result, for general-purpose glass windows and lenses, a TiO₂ coating may be unsuitable due to the high refractive index causing significant reflection. Also, thick coatings of TiO₂, while maximizing self-cleaning properties, may provide unacceptable attenuation at some wavelengths.

The proposed embodiments utilize a coating with an external TiO₂/air interface that achieves a high optical transmission over a particular range of wavelengths while providing the self-cleaning features described above. The range of wavelengths may include portions of the IR spectrum, such as near infrared (NIR) spectral bands. A TiO₂ coating with such properties may be useful, for example, in applications such as NIR surveillance cameras. This type of camera may use NIR LED illuminators with center wavelengths in the 780 nm to 1000 nm range. An NIR surveillance system may require light collection optical systems that are optically efficient over a relatively small range of wavelengths, and that can withstand exposure to the elements for long periods of time without maintenance (e.g., manual cleaning of viewing windows).

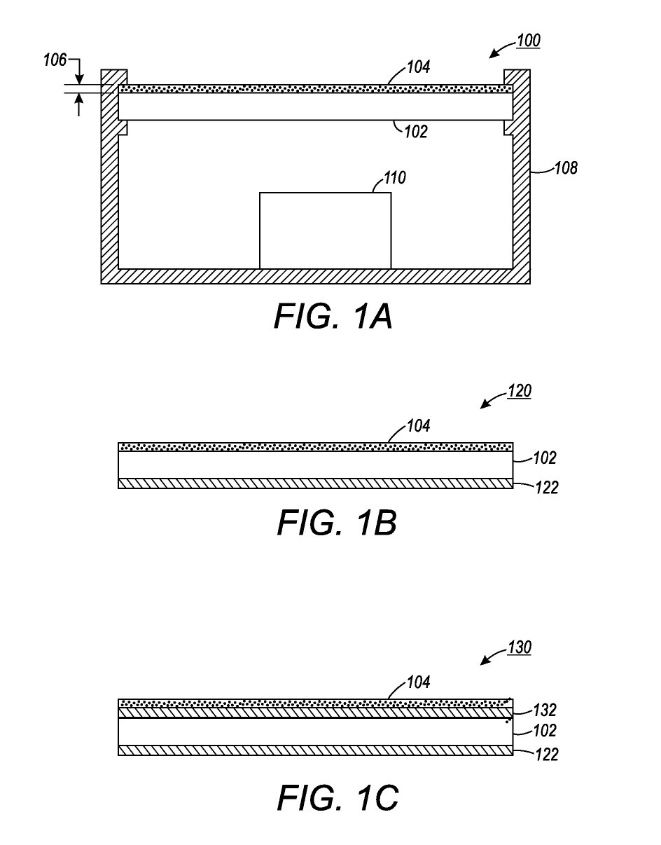

In reference now to FIG. 1A, a block diagram shows a window 100 according to one embodiment. The window 100 is formed from a sheet 102 of dielectric material (e.g., glass) that is transparent at least at a light wavelength of interest (e.g., NIR), and may be transparent over other wavelengths as well. The glass is used as a substrate for forming a externally facing coating 104 (not shown to scale) of a titanium dioxide, e.g., titanium dioxide (TiO₂). The surfaces of the glass 102 can be uncoated or anti-reflection (AR) coated prior to applying the TiO₂ coating 104.

It has been found that if only a small, predetermined, band of wavelengths is to be transmitted without significant attenuation through the window 100, a thicker coating 104 of TiO₂ tuned to those wavelengths can be applied, thus exhibiting the desired physical characteristics (e.g., self-cleaning) while permitting any desired treatment to the remainder of the optical assembly. In some applications of TiO₂ coatings, it may be permissible or even desirable to have a visible effect (e.g., lower reflection, greater transmissibility) on the transmitted light. However, this may require a thinner, less hardy and harder-to-apply coating.

The coating 104 has photocatalytic and photo-induced hydrophilic properties described above when combined with UV light. The TiO₂ coating 104 may have an optical thickness of approximately one half wavelength of light at a wavelength of interest, which can be extended to include m plus half the wavelength, where m=0, 1, 2, 3, . . . . This maximizes transmissibility of the coating 104 around that wavelength, and makes the window 100 substantially transparent at the wavelengths of interest. For NIR applications, the optical thickness may range from 390 nm to 500 nm.

The optical thickness of the coating 104 is proportional to a physical thickness 106 of the coating 104 based the refractive index of the coating 104 at the wavelength of interest. The optical thickness is equal to the physical thickness 106 multiplied by the refractive index of the layer material. So the optical thickness of the TiO₂ layer 104 for 850 nm light is 850 nm/2=425 nm, which corresponds to a physical thickness 106 of 425 nm/2.6=163 nm, where 2.6 is the refractive index of TiO₂ at 850 nm wavelength. The NIR optical thickness range from 390-500 nm noted above corresponds to a physical thickness 106 of 150-192 nm.

As shown in FIG. 1A, the window 100 may be used with an enclosure 108 to protect an optical device 110. The optical device is configured to emit and/or receive a narrowband spectrum of infrared light centered at a target wavelength, such as 850 nm which is in the NIR portion of the spectrum. The optical device 110 may include, but is not limited to, an infrared detector, camera, illuminator, etc. The window 100 is optimized to produce minimal attenuation for the light sent and/or received by the optical device 110. The window 100, together with the enclosure 108, provides a sealed environment that allows the device 110 to be used in harsh conditions. Due to the self-cleaning properties of the coating 104, the device 110 is provided with good visibility through the window 100, and this visibility can be maintained with minimum intervention even under harsh environmental conditions.

As mentioned above, a window according to example embodiments may include an AR coating. One type of AR coating is formed from a substance with a refractive index that is matched to the refractive index of the glass 102 to reduce reflections from the window 100, thereby improving light transmission efficiency. For example, a single layer AR coating may be chosen such that an index of refraction of the coating is the square root of the refractive index of the glass 102. Magnesium fluoride (MgF₂) has a refractive index of about 1.38, and is therefore often used as an AR coating for optical glass, which has an index of refraction of about 1.52. Other AR coatings may absorptive or include nanostructures that reduce reflections. More complex, higher performance multilayer AR coatings may also be used.

Example configurations of windows 120, 130 with an AR coating are shown in FIGS. 1B and 1C. For convenience, the same reference numbers are used to refer to like elements described in FIG. 1A, although it will be appreciated that the thicknesses, composition, etc., of these components may vary between different embodiment depending on the desired characteristics and interactions with the AR layers and coatings. In FIG. 1B, window 120 includes an AR coating 122 on a surface of the glass 102 opposite the TiO₂ coating 104. In FIG. 1C, window 130 includes an AR layer 132 between the TiO₂ coating 104 and glass 102. This window 130 also includes inside AR coating 122, although this coating layer 122 may be optional.

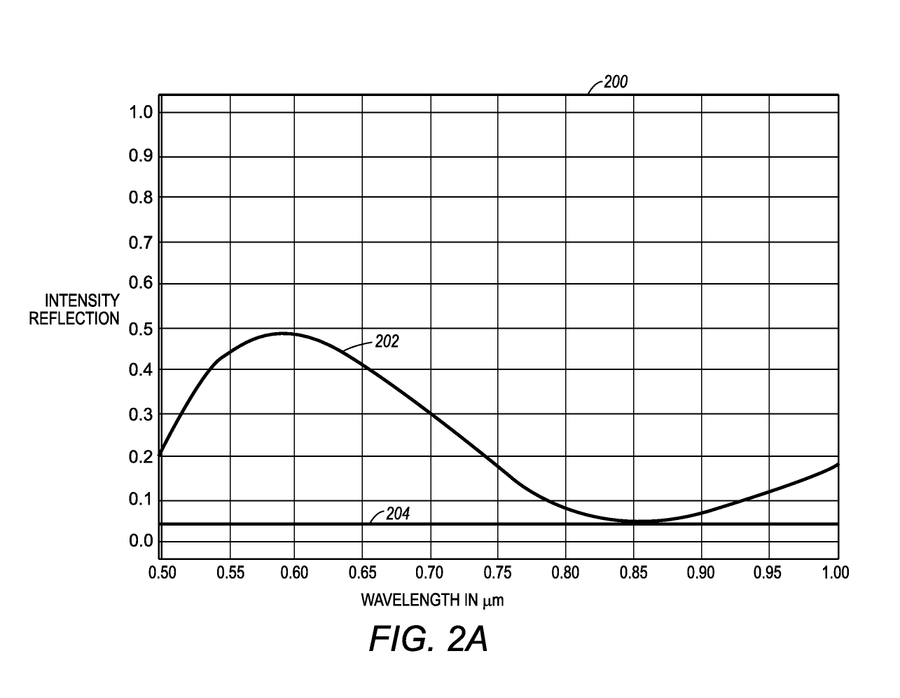

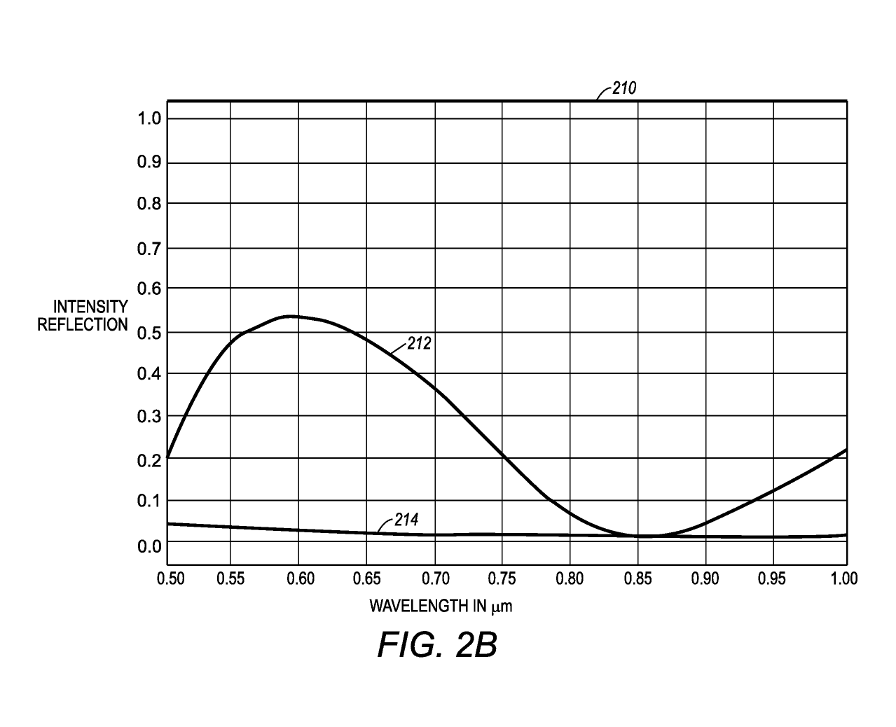

In FIGS. 2A and 2B, graphs 200, 210 show results of analyses performed on windows according to example embodiments. In FIG. 2A, curve 202 represents intensity reflection versus wavelength for a window arrangement 102 as shown in FIG. 1, with a TiO₂ coating 104 directly on glass 102 substrate. In this example, the optical thickness of the TiO₂ coating is 425 nm (which is equal to the refractive index of TiO₂ at 850 nm multiplied by the physical thickness 106 of the coating), corresponding to a half wavelength of 850 nm NIR light. Similar properties should hold for an optical thickness equal to m+½ times the infrared wavelength for m=0, 1, 2, 3, . . . . Curve 204 represents the same analysis for uncoated glass. As graph 200 shows, reflection of the TiO₂ coated surface (represented by curve 202) is nearly as low as uncoated glass (represented by curve 204) for wavelengths proximate 850 nm. The half-wavelength optically thick TiO₂ layer is not an AR coating, but instead behaves like a null coating at and near the center wavelength of the NIR.

In FIG. 2B, the graph 200 shows a similar analysis, but in this case curve 312 represents results for a TiO₂ coating with an optical thickness of 425 nm 104 is formed on an AR layer 132 as shown in FIG. 1C (without opposite facing AR layer 122). For this analysis, the AR layer 132 is formed of MgF₂ with 212.5 nm optical thickness (which is equal to the physical thickness of the layer multiplied by the refractive index 1.38 of MgF₂ at 850 nm). Curve 214 represents the same analysis for AR coated glass without a TiO₂ layer. Again, reflection of the TiO₂ coated surface (represented by curve 212) is nearly as low as the AR-only surface (represented by curve 212) for wavelengths proximate 850 nm. Also of note is that the minimum reflectance of curve 212 is lower than that of curve 202 in FIG. 2A. This shows that the AR coating is effective at the wavelength of interest, even with the addition of the TiO₂ outer coating.

As these results show, coating with a high refractive index (relative to glass) at an air interface can achieve high transmission performance in a dielectric (e.g., glass, plastic, etc.) window or lens spectral band or narrow spectral band. Optical coating designs that utilize a half-wave optically thick TiO2 layer can achieve high transmission in a dielectric (e.g., glass, plastic, etc.) window or lens within an LED emission spectral band or narrow spectral band. This technique can achieve a self-cleaning high transmission window or lens within an LED emission spectral band or narrow spectral band.

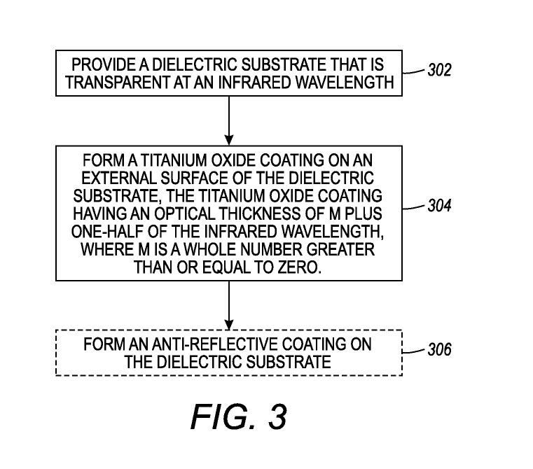

In reference now to FIG. 3, a flowchart illustrates a procedure according to an example embodiment. A dielectric substrate (e.g., glass, plastic) is provided 302, the substrate being is transparent at an infrared wavelength. A titanium dioxide coating is formed 304 on an external surface of the dielectric substrate. The titanium dioxide coating has an optical thickness m plus one-half of the infrared wavelength, where m is a whole number greater than or equal to zero. Optionally, an anti-reflective coating is formed 306 on the dielectric substrate.

The foregoing description of the example embodiments has been presented for the purposes of illustration and description. It is not intended to be exhaustive or to limit the invention to the precise form disclosed. Many modifications and variations are possible in light of the above teaching. Any or all features of the disclosed embodiments can be applied individually or in any combination are not meant to be limiting, but purely illustrative. It is intended that the scope of the invention be limited not with this detailed description, but rather determined by the claims appended hereto.

What is claimed is:

1. An optical transmission window, comprising:
a dielectric substrate that is transparent at an infrared wavelength; and
a titanium dioxide coating disposed on an external surface of the dielectric substrate, the titanium dioxide coating having an optical thickness of m plus one-half of the infrared wavelength, wherein m comprises a whole number greater than or equal to zero.

2. The optical transmission window of claim 1, further comprising an anti-reflective coating disposed on the dielectric substrate.

3. The optical transmission window of claim 2, wherein the anti-reflective coating is disposed on the external surface between the dielectric substrate and the titanium dioxide coating.

4. The optical transmission window of claim 3, further comprising a second anti-reflective coating disposed an internal surface opposite the external surface.

5. The optical transmission window of claim 1, wherein the anti-reflective coating is disposed on an internal surface opposite the external surface.

6. The optical transmission window of claim 1, wherein the dielectric substrate comprises glass.

7. The optical transmission window of claim 1, wherein the infrared wavelength comprises a near-infrared wavelength.

8. The optical transmission window of claim 1, wherein the titanium dioxide coating comprises a self-cleaning, hydrophilic coating.

9. An apparatus comprising:
an optical device configured to emit or receive a narrowband spectrum of infrared light centered at a target wavelength; and
an enclosure enclosing the optical device, the enclosure including an optical transmission window comprising:
a dielectric substrate that is transparent at an infrared wavelength; and
a titanium dioxide coating on an external surface of the dielectric substrate, the titanium dioxide coating having an optical thickness of m plus one-half of the infrared wavelength, wherein m comprises a whole number greater than or equal to zero.

10. The apparatus of claim 9, further comprising an anti-reflective coating disposed on the dielectric substrate.

11. The apparatus of claim 10, wherein the anti-reflective coating is disposed on the external surface between the dielectric substrate and the titanium dioxide coating.

12. The apparatus of claim 11, further comprising a second anti-reflective coating disposed an internal surface opposite the external surface.

13. The apparatus of claim 9, wherein the anti-reflective coating is disposed on an internal surface opposite the external surface.

14. The apparatus of claim 9, wherein the dielectric substrate comprises glass.

15. The apparatus of claim 9, wherein the narrowband spectrum comprises a near-infrared spectrum.

16. The apparatus of claim 9, wherein the titanium dioxide coating comprises a self-cleaning, hydrophilic coating.

17. A method comprising:
providing a dielectric substrate that is transparent at an infrared wavelength; and
forming a titanium dioxide coating on an external surface of the dielectric substrate, the titanium dioxide coating having an optical thickness of m plus one-half of the infrared wavelength, wherein m comprises a whole number greater than or equal to zero.

18. The method of claim 17, further comprising forming an anti-reflective coating on the dielectric substrate.

19. The method of claim 17, wherein the infrared wavelength comprises a near-infrared wavelength.

20. The method of claim 17, wherein the titanium dioxide coating comprises a self-cleaning, hydrophilic coating.
